(19) United States
(12) Patent Application Publication
(10) Pub. No.: US 2025/0106782 A1
(43) Pub. Date: Mar. 27, 2025

(54) BASE STATION CONTROL SYSTEM, BASE STATION CONTROL METHOD, BASE STATION CONTROL APPARATUS AND PROGRAM

(71) Applicant: NIPPON TELEGRAPH AND TELEPHONE CORPORATION, Tokyo (JP)

(72) Inventors: Toshiro NAKAHIRA, Tokyo (JP); Motoharu SASAKI, Tokyo (JP); Daisuke MURAYAMA, Tokyo (JP); Shota NAKAYAMA, Tokyo (JP); Takatsune MORIYAMA, Tokyo (JP); Yasushi TAKATORI, Tokyo (JP)

(21) Appl. No.: 18/294,703

(22) PCT Filed: Sep. 1, 2021
(86) PCT No.: PCT/JP2021/032190

§ 371 Date: Feb. 2, 2024

(51) Int. Cl. H04W 52/28; H04W 16/18

(52) U.S. Cl. CPC H04W 52/283; H04W 16/18

(57) ABSTRACT

In a base station control system including a first base station whose deployment position has not been determined and a base station control apparatus, the base station control apparatus reduces a deviation in the number of terminals connected to each base station by including a clustering unit configured to repeat clustering for dividing a plurality of terminals into clusters for each of the first base station and a second base station while fixing a position of the existing second base station to which the plurality of terminals is connected and changing a position of the first base station, a calculation unit configured to calculate a number of first terminals connected to the first base station and a number of second terminals connected to the second base station for each of a plurality of transmission powers of the first base station in a case where the first base station is deployed at a position at a point in time at which the clustering is completed, and a selection unit configured to select a transmission power of the first base station on the basis of the number of first terminals and the number of second terminals.

### TECHNICAL FIELD

The present invention relates to a base station control system, a base station control method, a base station control apparatus, and a program.

### BACKGROUND ART

In a case where wireless base stations are evenly deployed in an area in order to efficiently secure an area coverage, it is considered that a communication quality for a specific area deteriorates due to the influence of terminal congestion, shielding, and the like. On the other hand, a technique of dynamically deploying a movable base station in an area having a deteriorated communication quality to ameliorate the deterioration in the communication quality has been studied (Non-Patent Document 1).

### CITATION LIST

### Non-Patent Document

Non-Patent Document 1: Takuto Arai, Daisuke Gotou, Masashi Iwabuchi, Tatsuhiko Iwakuni, and Kazuaki Maruta, “AMAP: Adaptive Movable Access Point System for Offloading Efficiency Enhancement”, IEICE Technical Report, vol. 116, no. 46, RCS2016-43, pp. 107-112, May 2016

### SUMMARY OF INVENTION

### Technical Problem

However, when the movable base station is dynamically deployed, if power that is from the movable base station and is received by each of terminals is excessively large, compared to other base stations, many terminals are autonomously connected to the movable base station, and excessive deviation in the terminal connection may occur, which may result in reductions in the communication quality.

FIG. 1 is a diagram for describing a problem of a conventional technology. In FIG. 1, an exemplary case in which two movable base stations are additionally installed in an environment where there are three existing base stations and 11 terminals will be described as follows. (1) of FIG. 1 illustrates a state before the movable base stations are deployed, and (2) illustrates a state after the movable base stations are deployed.

In (1) in which the state is held before the movable base stations are deployed, one terminal is connected to an existing base station on the left-hand side, and five terminals are connected to each of the other two existing base stations. A broken line connecting each terminal and the existing base station indicates a connection relationship between the terminal and the existing base station. In this state, the two existing base stations are congested. Therefore, by deploying one movable base station for each of the two existing base stations, the congestion is resolved or alleviated.

In the conventional technology, a deployment position of the movable base station is calculated by clustering 10 terminals connected to any one of the two congested existing base stations. As a result, for example, movable base stations are installed as illustrated in (2). In (2), each cluster is indicated by a frame line in a curve, and an example in which the movable base station is deployed at a center of gravity of each cluster is shown.

When a given terminal can receive signals from a plurality of base stations, the given terminal operates to connect to a base station such that the highest received power is obtained in a general wireless system. Therefore, when the movable base stations are deployed as illustrated in (2), five terminals are connected to one movable base station, and two terminals are connected to the other movable base station. As a result, congestion of the existing base stations in which the congestion occurs in (1) is resolved, but one movable base station becomes congested. As described above, according to the conventional technology, there is a possibility that the number of terminals that are connected to each base station is excessively unequal (existing base station or movable base station).

The present invention has been made in view of the above points, and an object of the present invention is to reduce an unequal number of terminals connected to each base station.

### Solution to Problem

Therefore, in order to solve the above problem, the present invention provides a base station control system including a first base station whose deployment position has not been determined and a base station control apparatus, in which the base station control apparatus includes: a clustering unit that fixes a position of an existing second base station to which a plurality of terminals are connected and repeats clustering to divide the plurality of terminals into clusters for each of the first base station and the second base station while changing the position of the first base station; a calculation unit that calculates, for each of a plurality of transmission powers of the first base station, the number of first terminals connected to the first base station and the number of second terminals connected to the second base station in a case where the first base station is deployed at a position at a time point when the clustering is finished; and a selection unit that selects a transmission power of the first base station on the basis of the number of first terminals and the number of second terminals.

### Advantageous Effects of Invention

It is possible to reduce an unequal number of terminals connected to each base station.

### BRIEF DESCRIPTION OF DRAWINGS

FIG. 1 is a diagram for describing a problem of a conventional technology.

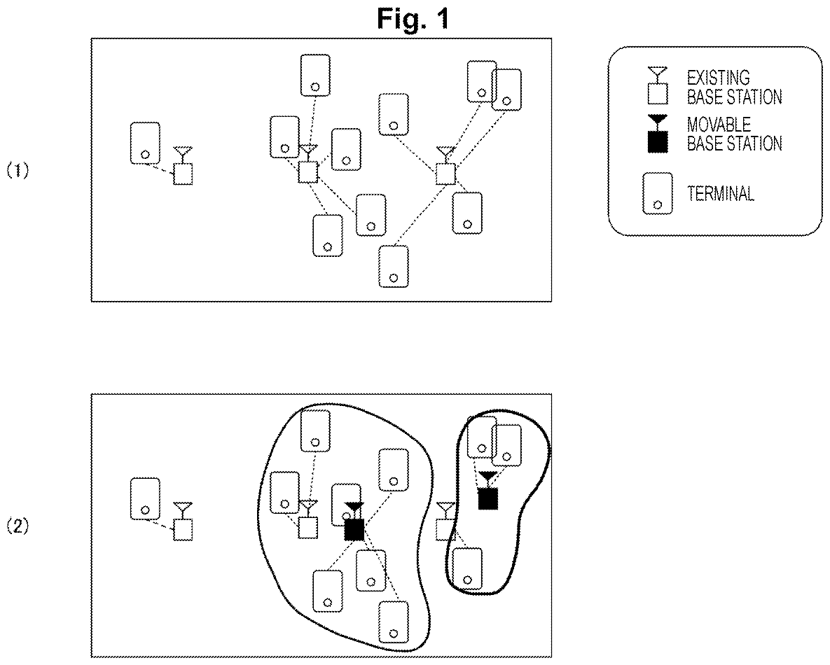

FIG. 2 is a diagram illustrating a configuration example of a communication system 1 according to an embodiment of the present invention.

FIG. 3 is a diagram illustrating a hardware configuration example of a control station 10 in the embodiment of the present invention.

FIG. 4 is a diagram illustrating a functional configuration example of the control station 10 in the embodiment of the present invention.

FIG. 5 is a flowchart for describing an example of a processing procedure executed by the control station 10.

FIG. 6 is a diagram illustrating a specific example of a connection state of a terminal 50 to an existing base station 30.

FIG. 7 is a diagram illustrating an example of possible patterns.

FIG. 8 is a diagram illustrating an example of a calculation result of an evaluation value X of each possible pattern.

FIG. 9 is a diagram illustrating an example of a calculation result of an evaluation value Yi of each possible pattern.

FIG. 10 is a flowchart for describing an example of a processing procedure of clustering processing.

### DESCRIPTION OF EMBODIMENTS

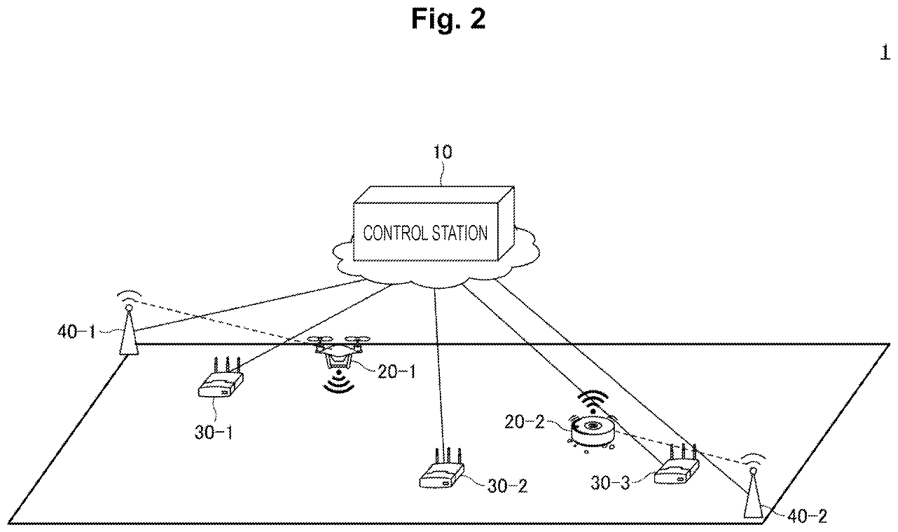

Hereinafter, embodiments of the present invention will be described with reference to the drawings. FIG. 2 is a diagram illustrating a configuration example of a communication system in an embodiment of the present invention. As illustrated in FIG. 2, the communication system 1 includes one or more existing base stations 30, one or more movable base stations 20, one or more relay base stations 40, a control station 10, and the like. Note that a base station refers to a base station (access point) in wireless communication (for example, a wireless LAN).

The existing base station 30 is an existing base station in the present embodiment. In the present embodiment, the existing base station 30 is not targeted for movement, but the existing base station 30 may be movable.

The movable base station 20 is a base station that is movable, and is a base station that is newly deployed (deployment position is not determined) in the present embodiment. For example, in a case or the like where communications with a certain existing base station 30 becomes congested, the movable base station 20 is dynamically deployed. Note that a drive approach to move the movable base station 20 is not limited to a specific device. For example, a vehicle, a drone, or the like may be used as the drive approach. In addition, the movable base station 20 may be configured to move on a rail provided in advance.

The relay base station 40 is a base station that relays communication between the movable base station 20 and the control station 10. The relay base station 40 is connected to the movable base station 20 by wireless communications. Therefore, the movable base station 20 is movable within a range in which wireless communications with the relay base station 40 can be performed.

Note that, hereinafter, in a case where the existing base station 30 and the movable base station 20 are not distinguished, they are simply referred to as “base stations.” In addition, although not illustrated, there are a plurality of terminals (hereinafter referred to as terminals 50) that are wirelessly connected to any base station and perform communications with the base station. Each terminal is connected to any base station by autonomous control. The autonomous control is, for example, a control in which the terminal is connected to a base station that allows relatively large power to be received by the terminal.

The control station 10 is one or more computers that control deployment of the movable base station 20 and control the transmission power of the movable base station 20. The control station 10 is connected to each existing base station 30 and each relay base station 40 via a network (wired or wireless). The control station 10 controls deployment of the movable base station 20 and the transmitted power of the movable base station 20, on the basis of information that is collected from each base station and terminal via the network.

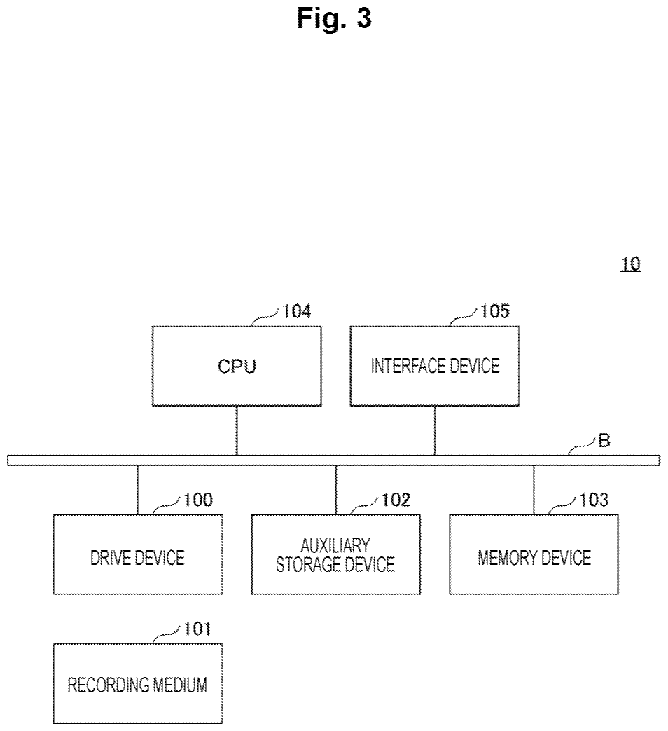

FIG. 3 is a diagram illustrating a hardware configuration example of the control station 10 in the embodiment of the present invention. The control station 10 of FIG. 3 includes a drive device 100, an auxiliary storage device 102, a memory device 103, a CPU 104, an interface device 105, and the like which are connected to one another via a bus B.

A program for realizing processing in the control station 10 is provided by a recording medium 101 such as a CD-ROM. When the recording medium 101 storing the program is set in the drive device 100, the program is installed on the auxiliary storage device 102 from the recording medium 101 via the drive device 100. Here, the program is not necessarily installed from the recording medium 101 and may be downloaded from another computer via the network. The auxiliary storage device 102 stores the installed program and also stores necessary files, data, and the like.

When an instruction to start the program is received, the memory device 103 reads the program from the auxiliary storage device 102 to store the program in the memory device 103. The CPU 104 executes a function related to the control station 10 according to the program stored in the memory device 103. The interface device 105 is used as an interface for connecting to the network.

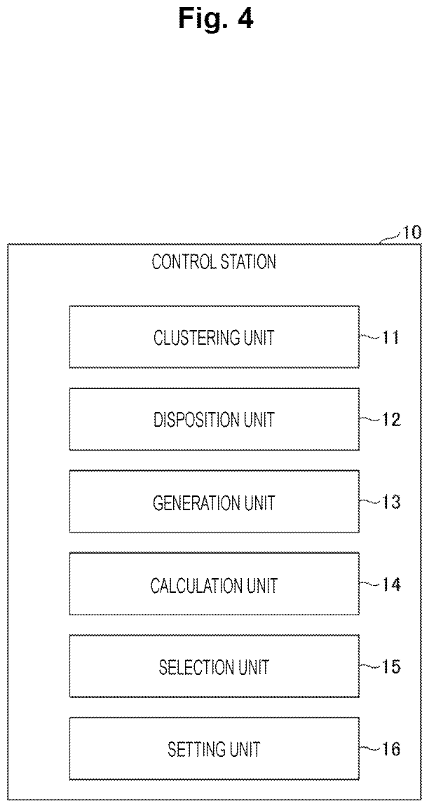

FIG. 4 is a diagram illustrating a functional configuration example of the control station 10 in the embodiment of the present invention. In FIG. 4, the control station 10 includes a clustering unit 11, a deployment unit 12, a generation unit 13, a calculation unit 14, a selection unit 15, and a setting unit 16. Each of these units is implemented by the CPU 104 executing one or more programs that are installed in the control station 10.

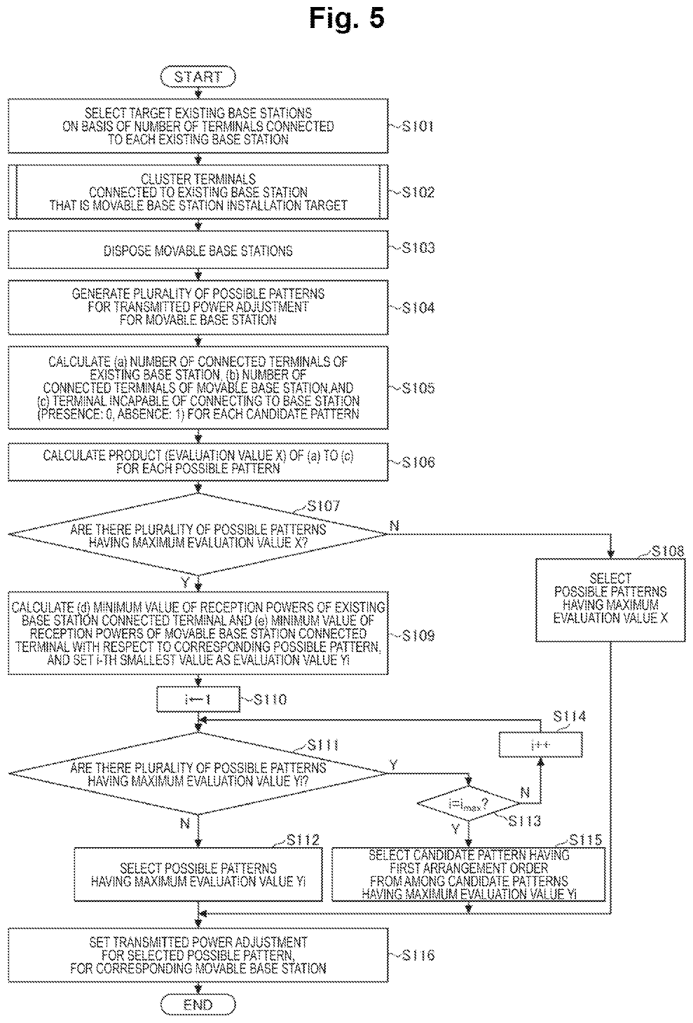

Hereinafter, a processing procedure executed by the control station 10 will be described. FIG. 5 is a flowchart for describing an example of the processing procedure executed by the control station 10.

In step S101, the clustering unit 11 selects one or more existing base stations 30 (whose burden is to be reduced by the movable base station 20) (hereinafter, referred to as “target existing base stations 30”) as targets for which the movable base station 20 is to be installed, on the basis of the number of terminals connected to each of the plurality of existing base stations 30. For example, a portion of the existing base stations 30 for which connection to given terminals becomes relatively congested (the number of connected terminals is relatively large) is selected as the target existing base stations 30. In this case, for each existing base station 30, the clustering unit 11 determines whether the connection to given terminals is congested. For example, the clustering unit 11 determines that the existing base station 30 to which the number of terminals 50 connected (the number of connected terminals) is equal to or greater than a predetermined threshold value is congested.

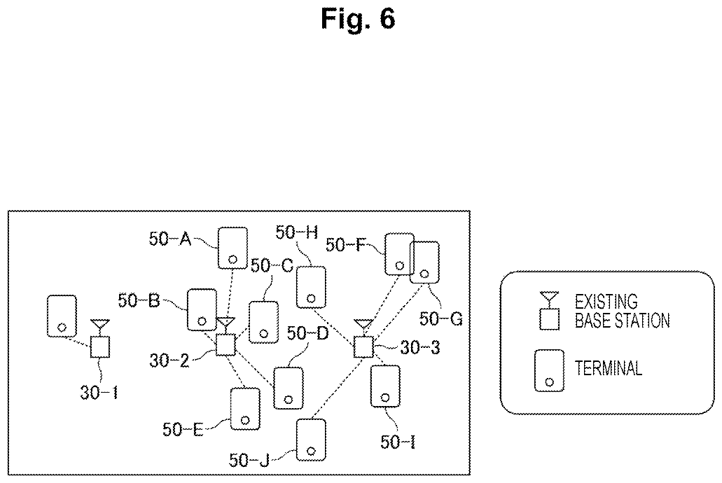

FIG. 6 is a diagram illustrating a specific example of the connection states of the terminals 50 to the existing base stations 30. In the present embodiment, it is assumed that three existing base stations 30 are installed, and two movable base stations 20 are additionally installed in a state where 11 terminals 50 are connected to any of the existing base stations 30. In the figure, a broken line connecting each terminal 50 and the existing base station 30 indicates a connection relationship (which existing base station 30 is connected to the terminal 50) between the terminal 50 and the existing base station 30. Therefore, in the example of FIG. 6, the number of terminals connected to an existing base station 30-1 is 1, the number of terminals connected to an existing base station 30-2 is 5, and the number of terminals connected to an existing base station 30-3 is 5.

In the example of FIG. 6, when the threshold value for determining whether the existing base station 30 is congested is 5, it is determined that two existing base stations 30, that is, existing base stations 30-2 and 30-3 are congested. Therefore, these two existing base stations 30 are selected as target existing base stations 30.

Alternatively, as another determination method, if the number of connected terminals is within α% of all the existing base stations 30, it may be determined that congestion has occurred, and otherwise, it may be determined that congestion does not occur. α is a parameter, and for example, when α=50 is satisfied, the existing base stations 30 that are in the top 50% are in a congestion state.

Alternatively, as another determination method, each existing base station 30 to which the number of terminals that are connected to exceeds an average number of connected terminals for all the existing base stations 30 may be determined to be in a congestion state.

Subsequently, the clustering unit 11 performs clustering (non-hierarchical clustering (k-means++)) on terminals 50 connected to the target existing base stations 30, thereby dividing the terminals 50 connected to the target existing base stations 30 into the number of clusters (a cluster for each target existing base station 30 and for each movable base station 20) that is defined (by adding the number of target existing base stations and the number of movable base stations) (S102). At this time, the clustering unit 11 repeats clustering under the constraint that positions of the target existing base stations 30 are fixed while changing positions of the movable base stations 20, until a result of the clustering does not change. Details of step S102 will be described later.

Subsequently, the deployment unit 12 determines the position of each movable base station 20 at a timing at which the clustering is completed, as a deployment position of the movable base station 20, and then performs a control to deploy the movable base station 20 at the deployment position (S103). Specifically, the deployment unit 12 transmits, to each movable base station 20, an instruction to move the movable base station 20 to the determined deployment position. Each movable base station 20 moves to the deployment position designated by the instruction.

When the deployment of each movable base station 20 is completed, the generation unit 13 generates multiple different patterns that are enabled for a combination of transmitted power adjustment for the movable base stations 20 (S104). Hereinafter, the patterns are referred to as “possible patterns.” The transmitted power adjustment refers to relative power that is obtained by decreasing from maximum transmitted power. For example, since the transmitted power to be set varies depending on the country, the transmitted power is set using a relative value that is obtained based on a maximum value in the present embodiment. However, the possible patterns may be configured using an absolute value of the transmitted power instead of the transmitted power adjustment.

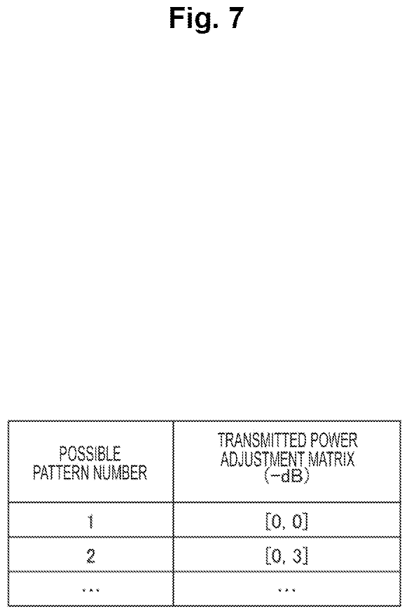

FIG. 7 is a diagram illustrating an example of the possible patterns. As illustrated in FIG. 7, a possible pattern number and a transmitted power adjustment matrix are generated for each possible pattern in step S104. The possible pattern number is an identification number of the possible pattern. The transmitted power adjustment matrix is a combination of transmitted power adjustment for movable base stations 20. For example, in [0, 0] in FIG. 7, 0 in a first column indicates transmitted power adjustment for one movable base station 20, and 0 in a second column indicates transmitted power adjustment for the other movable base station 20.

Subsequently, the calculation unit 14 calculates evaluation parameters of each possible pattern, on the basis of the position of each base station, the position of each terminal 50 (each terminal 50 connected to any target base station), the transmitted power of each base station, and the like (S105). In the present embodiment, the evaluation parameters includes (a) the number of terminals connected to a given existing base station, (b) the number of terminals connected to a given movable base station 20, and (c) one or more terminals that are incapable of connecting to any base station.

(a) The number of terminals connected to a given existing base station, for a certain possible pattern, refers to the number of terminals 50 connected to each target existing base station 30 when the transmitted power adjustment of each movable base station 20 is set as illustrated in the possible pattern.

(b) The number of terminals connected to a given movable base station 20, for a certain possible pattern, refers to the number of terminals 50 connected to each movable base station 20 when the transmitted power adjustment for the movable base station 20 is set as illustrated in the possible pattern.

(c) The one or more terminals incapable of connecting to any base station, for a certain possible pattern, refers to one or more terminals 50 that cannot be connected to any one of the movable base stations 20 and the target existing base stations 30, among the terminals 50 present in an area in which the existing base stations 30 are deployed when the transmitted power adjustment for the movable base stations 20 is set as illustrated in the possible pattern. A value set in (c) is 0 when there is a terminal 50 corresponding to the one or more terminals incapable of connecting to any base stations, and when there is no terminal 50 corresponding to the one or more terminals incapable of connecting to any base station, the value set in (c) is 1.

With respect to (a) and (b), the calculation unit 14 calculates power that is from a corresponding station among the target existing base stations 30 and the movable base stations 20 and is received by each terminal 50, on the basis of a distance between the terminal 50 and the corresponding station among the target existing base stations 30 and the movable base stations 20; and transmitted power of the corresponding station among the target existing base stations 30 and the movable base stations 20. Then, the calculation unit 14 calculates the number of terminals connected to each base station when one or more terminals 50 are connected to a given base station that allows the largest received power.

With respect to (c), the calculation unit 14 determines the presence or absence of any terminal 50, for which a maximum value (the greatest value among received power that is from the target existing base stations 30 and received power that is from the movable base stations 20) of received power calculated for the base stations, corresponding to the terminals 50 defined in (a) and (b), is below a predetermined threshold value (required reception power) as a determination result.

Subsequently, the calculation unit 14 calculates an evaluation value X on the basis of (a) to (c), for each possible pattern (S106). Here, as an example, a product ((a)×(b)×(c)) of (a), (b), and (c) is calculated as the evaluation value X.

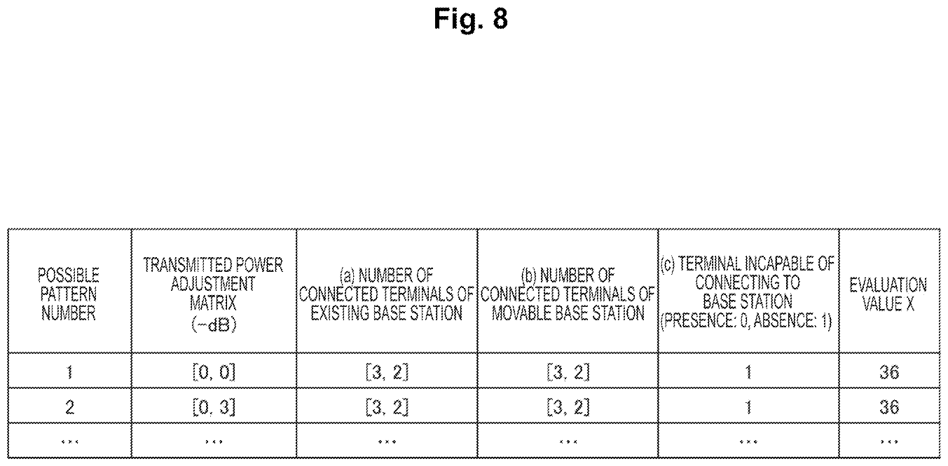

FIG. 8 is a diagram illustrating an example of a calculation result of the evaluation value X for each possible pattern. FIG. 8 illustrates an example of the values of (a) to (c) and an example of the evaluation value X, for each possible pattern.

Subsequently, the selection unit 15 determines whether there are a plurality of possible patterns for which the greatest evaluation value X is obtained (S107). If there is one possible pattern for which the greatest evaluation value X is obtained (N in S107), the selection unit 15 selects the one possible pattern (S108) and proceeds to step S116. Note that the possible pattern for which the greatest evaluation value X is obtained is a pattern for which a difference between the numbers of terminals connected to respective base stations is small and for which there is no terminal incapable of connecting to a base station, and thus transmitted power adjustment that allows reductions in unequal numbers of terminals connected to the movable base stations 20.

On the other hand, if there are a plurality of possible patterns for which the greatest evaluation value X is obtained (that is, in a case where a possible pattern cannot be uniquely selected based on the evaluation value X,) (Y in S108), the selection unit 15 calculates, for each possible pattern for which the greatest evaluation value X is obtained, (d) a minimum value of received power by an terminal connected to the existing base station and (e) a minimum value of received power by a terminal connected to the movable base station, and then the selection unit 15 sets the i-th (i=1, 2) value (that is, the i-th smallest value) in ascending order of (d) and (e) as an evaluation value Yi for the possible pattern (S109). Note that the terminal connected to the existing base station for a certain possible pattern refers to a terminal 50 connected to a target existing base station 30 when the transmitted power adjustment for one or more movable base stations 20 is obtained as illustrated in the possible pattern (a terminal 50 for which received power from the target existing base station 30 is larger than received power from the movable base station 20). Further, the terminal connected to the movable base station for a certain possible pattern refers to a terminal 50 connected to a movable base station 20 when the transmitted power adjustment for one or more movable base stations 20 is obtained as illustrated in the possible pattern (a terminal 50 for which received power from the movable base station 20 is larger than received power from the target existing base station 30). Therefore, (d) the minimum value of the received power by the terminal connected to the existing base station refers to a minimum value of power of signals that are from the existing base stations 30 and are received by one or more terminals connected to the existing base stations. (e) The minimum value of received power by the terminal connected to the movable base station refers to a minimum value of power of signals that are from the movable base stations 20 and are received by one or more terminals connected to the movable stations. Note that power that is from each base station and is received by a given terminal 50 can be calculated on the basis of the distance between the base station and the given terminal 50; transmitted power of the base station; and the like.

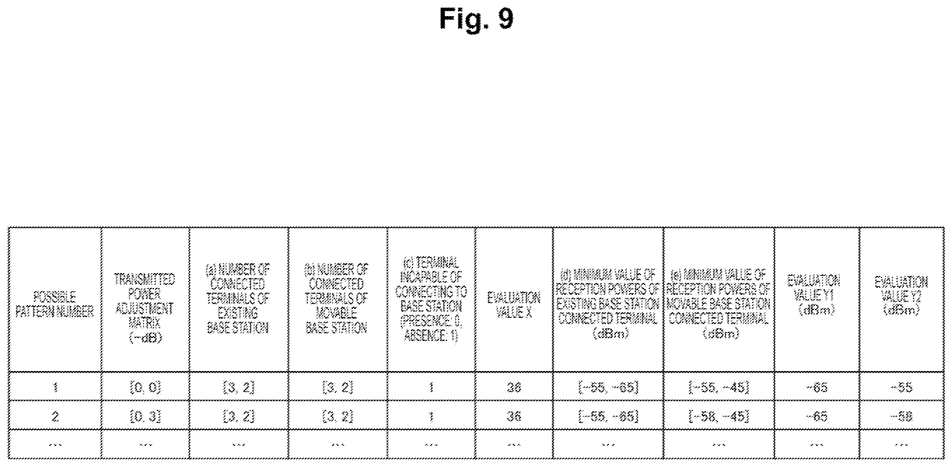

FIG. 9 is a diagram illustrating an example of a calculation result of the evaluation value Yi for each possible pattern. For each possible pattern for which a maximum evaluation value X is obtained, FIG. 9 further illustrates (d) the minimum value of received power by the terminal connected to the existing base station, (e) the minimum value of received power by the terminal connected to the movable base station, an evaluation value Y1, and an evaluation value Y2.

Subsequently, the selection unit 15 substitutes 1 into a variable i (S110). Subsequently, the selection unit 15 determines whether there are a plurality of possible patterns for which the maximum evaluation value Yi is obtained (S111). If there is one possible pattern for which the maximum evaluation value Yi is obtained (N in S111), the selection unit 15 selects the possible pattern (S112) and proceeds to step S116.

On the other hand, if there are a plurality of possible patterns for which the maximum evaluation value Yi is obtained (Y in S111), the selection unit 15 determines whether a value of the variable i matches iₘₐₓ (S113). The iₘₐₓ is a total number of the target existing base stations 30 and the movable base stations 20. If i does not match the iₘₐₓ (N in S113), the selection unit 15 adds 1 to i (S114), and then repeats step S111 and subsequent steps.

If i matches iₘₐₓ (Y in S113), the selection unit 15 selects a possible pattern that is placed first in FIG. 9 (of the smallest possible pattern number), among possible patterns for which the maximum evaluation value Yi is obtained (S115), and then proceeds to step S116. After step S109, a possible pattern for which power is larger than the minimum power of the signal received by the terminal 50 can be selected.

In step S116, the setting unit 16 sets the transmitted power adjustment for the possible pattern selected in step S108, S112, or S115, for a corresponding movable base station 20.

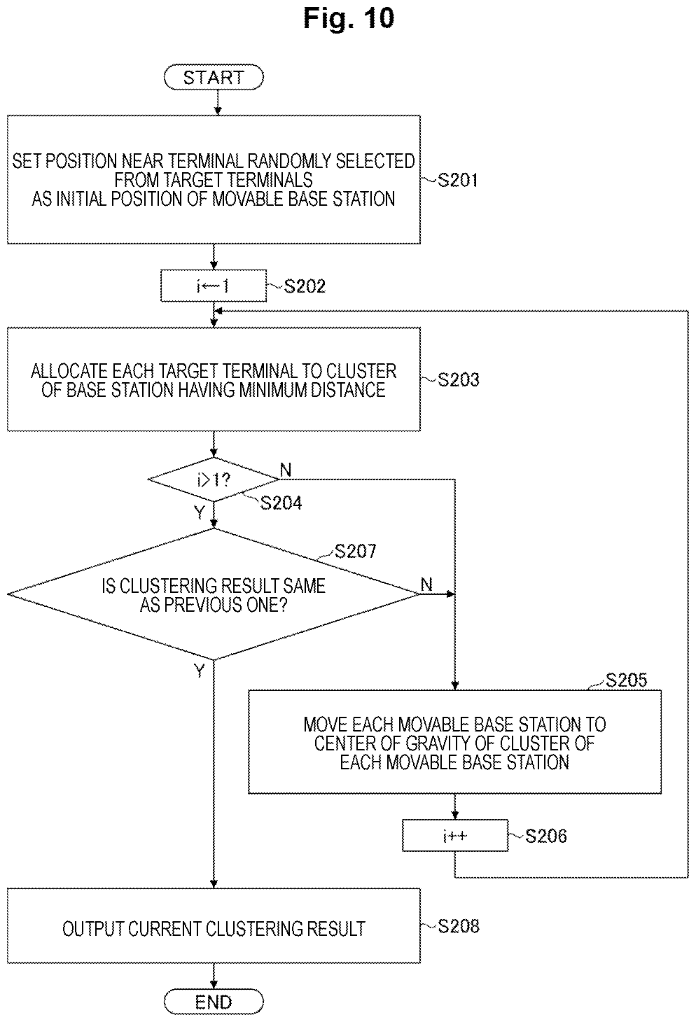

Next, details of step S102 will be described. FIG. 10 is a flowchart for describing an example of a processing procedure of clustering processing.

In step S201, for each movable base station 20, the clustering unit 11 randomly selects any one of a plurality of terminals 50 (hereinafter, referred to as “target terminals 50”) that are each connected to any one of the target existing base stations 30, and then sets a position in the vicinity of the target terminal 50 as an initial position of the movable base station 20. The position in the vicinity of the terminal 50 is, for example, an arbitrary position within a range that is defined using a predetermined radius from the terminal 50. Alternatively, the position in the vicinity of the terminal 50 may be a position where another terminal 50 closer than the terminal 50 is not present.

Subsequently, the clustering unit 11 substitutes 1 into the variable i (S202). The variable i is a variable for storing the number of executions after step S203.

Subsequently, the clustering unit 11 calculates, for each target terminal 50, a distance to a corresponding target existing base station 30 and a distance to a corresponding movable base station 20, and then assigns the target terminal 50 to a cluster related to a base station for which the smallest distance is obtained (S203). That is, the cluster is generated for each of the movable base stations 20 and the target existing base stations 30, and each target terminal 50 is assigned to a corresponding cluster that is the closest to a given base station among the movable base stations 20 and the target existing base stations 30.

Subsequently, the clustering unit 11 determines whether the variable i is greater than 1 (S204). If the variable i is 1 or less (N in S204), the clustering unit 11 moves, for each movable base station 20, the movable base station 20 to the center of gravity of a cluster related to the movable base station 20 (the center of gravity of a group of target terminals 50 belonging to the cluster) (S205). Subsequently, the clustering unit 11 adds 1 to i (S206), and executes step S203 and subsequent steps.

If the variable i is 2 or less (Y in S204), the clustering unit 11 determines whether the current clustering result is the same as a previous clustering result (when i−1 is satisfied) (S207). The clustering result refers to information indicating which target terminal 50 belongs to any cluster related to a given base station.

If the current clustering result is different from the previous clustering result (that is, in a case where clustering has not converged) (N in S207), the clustering unit 11 executes step S205 and subsequent steps.

If the current clustering result is the same as the previous clustering result (that is, in a case where clustering has not converged) (N in S207), the clustering unit 11 outputs the current clustering result (S208).

According to the above processing, it is possible to determine deployment positions of the movable base stations 20 by performing clustering under the condition in which deployment of only the movable base stations 20 is changed without moving the existing base stations 30.

As described above, according to the present embodiment, it is possible to reduce unequal numbers of terminals connected to base stations. As a result, improvements in the communication quality can be expected.

Note that, when a base station can set different transmitted power by using a beacon signal and a data signal, in a case where the transmitted power is reduced, only the transmitted power of the beacon signal may be reduced without reducing transmitted signal power of data signal.

In addition, one or more deployment candidates of the movable base stations 20 may be limited in advance in consideration of an area in which the communications are performed via one or more backhaul lines that connect the movable base stations 20.

In addition, in a case where the movable base stations 20 can be adjusted, taking into account a height direction, a plurality of deployment candidates of movable base stations 20 may also be prepared taking into account the height direction.

Further, in a case where the movable base station 20 can change a beam transmission direction (direction in which analog beamforming is performed, selection of an antenna pattern that is performed using digital beamforming, and the like), possible patterns may be further distinguished depending on beam transmission directions that are switched.

In addition, the present embodiment may be applied not only to the movable base stations 20 but also to deployment of fixed base stations and the like. For example, the present embodiment may be applied to a determination of a deployment position and transmitted power of a newly installed fixed base station.

Note that, in the present embodiment, the movable base station 20 is an example of a first base station. The existing base station 30 is an example of a second base station. The control station 10 is an example of a base station control apparatus.

### REFERENCE SIGNS LIST

1 Communication system
10 Control station
11 Clustering unit
12 Deployment unit
13 Generation unit
14 Calculation unit
15 Selection unit
16 Setting unit
20 Movable base station
40 Relay base station
30 Existing base station
50 Terminal
100 Drive device
101 Recording medium
102 Auxiliary storage device
103 Memory device
104 CPU
105 Interface device
B Bus

1. A base station control system comprising:
a first base station whose placement position is undetermined; and
a base station control apparatus including circuitry configured to
repeat clustering in which a plurality of terminals are divided into clusters for each of the first base station and at least one existing second base station while fixing a position of the existing second base station to which one or more terminals among the plurality of terminals are connected and changing a position of the first base station;
determine (i) the number of first terminals connected to the first base station and (ii) the number of second terminals connected to the second base station, for each unit of power in a set of transmitted power units of the first base station in a case where the first base station is placed at the position at which the clustering is terminated; and
determine a given transmitted power unit of the first base station, based on the number of first terminals and the number of second terminals.

2. The base station control system according to claim 1, wherein the at least one second base station includes a part of existing base stations for each of which the number of terminals connected is greater than or equal to a threshold.

3. The base station control system according to claim 1, wherein the circuitry is configured to
determine the number of third terminals that are not to be connected to both the first base station and the second base station, for each unit of power in the set of transmitted power units of the first base station, and
determine the given transmitted power unit of the first base station, based on the number of first terminals, the number of second terminals, and the number of third terminals.

4. The base station control system according to claim 1, wherein upon occurrence of a condition in which the given transmitted power unit is not determined, the circuitry is configured to determine the given transmitted power unit of the first base station based on (i) power that is transmitted from the first base station and is received by one or more first terminals and (ii) power that is transmitted from the second base station and is received by one or more second terminals, the power received by the one or more first terminals and the power received by the one or more second terminals being determined for each unit of power in the set of transmitted power units.

5. A base station control method executed by a base station control apparatus for controlling a first base station whose placement position is undetermined, the base station control method comprising:
repeating clustering in which a plurality of terminals are divided into clusters for each of the first base station and at least one second base station while fixing a position of the second base station to which one or more terminals among the plurality of terminals are connected and changing a position of the first base station;
determining (i) the number of first terminals connected to the first base station and (ii) the number of second terminals connected to the second base station, for each unit of power in a set of transmitted power units of the first base station in a case where the first base station is placed at the position at which the clustering is terminated; and
determining a given transmitted power unit of the first base station, based on the number of first terminals and the number of second terminals.

6. A base station control apparatus for controlling a first base station whose placement position is undetermined, the base station control apparatus comprising:
circuitry configured to
repeat clustering in which a plurality of terminals are divided into clusters for each of the first base station and at least one existing second base station while fixing a position of the existing second base station to which one or more terminals among the plurality of terminals are connected and changing a position of the first base station;
determine (i) the number of first terminals connected to the first base station and (ii) the number of second terminals connected to the second base station, for each unit of power in a set of transmitted power units of the first base station in a case where the first base station is placed at the position at which the clustering is terminated; and
determine a given transmitted power unit of the first base station, based on the number of first terminals and the number of second terminals.

7. A non-transitory computer readable medium storing a program causing a computer to execute the base station control method of claim 5.
